(19) United States
(12) Patent Application Publication
(10) Pub. No.: US 2022/0373071 A1
(43) Pub. Date: Nov. 24, 2022

(54) Torque Convertor with an Insert Molded Thrust Washer

(71) Applicant: ZF Friedrichshafen AG, Friedrichshafen (DE)

(72) Inventor: Cesar Cerecero, Saltillo (MX)

(21) Appl. No.: 17/327,966

(22) Filed: May 24, 2021

(51) Int. Cl. F16H 45/02; B29C 45/14

(52) U.S. Cl. CPC F16H 45/02; B29C 45/14336; F16H 2045/0226; F16H 2045/0263; B29C 2045/1495; B29L 2031/748

(57) ABSTRACT

A torque converter includes an impeller, a turbine, a stator, a one-way clutch, and an insert molded thrust washer formed onto a retention mount that is integrally formed on one of the impeller, the turbine, the stator, and the one-way clutch. The retention mount defines an undercut. At least a portion of the insert molded thrust washer is disposed within the undercut. Interference between the retention mount and the insert molded thrust washer mounts the insert molded thrust washer to the retention mount.

### FIELD OF THE INVENTION

The present subject matter relates generally to torque converter thrust washers.

### BACKGROUND OF THE INVENTION

Torque converters generally include an impeller, a turbine and a stator. An engine coupled to the torque converter rotates the impeller to flow fluid within the torque converter from the impeller to the turbine. The flowing fluid from the impeller drives rotation of the turbine, and the turbine is coupled to an input shaft of an associated automatic transmission. Thus, the fluid within the torque converter can hydraulically connect the impeller and the turbine.

After the fluid from the impeller strikes the turbine, the fluid changes direction and recirculates back towards the impeller. Between the turbine and the impeller, the stator redirects the fluid recirculating from the turbine towards the impeller. The stator increases a turbine torque of the torque converter by changing the flow direction of the fluid.

Certain torque converters include a thrust washer between the stator and the turbine. However, components for fixing or clamping the thrust washer within the torque converter add to the complexity and cost of the torque converter.

### BRIEF DESCRIPTION OF THE INVENTION

Aspects and advantages of the invention will be set forth in part in the following description, or may be apparent from the description, or may be learned through practice of the invention.

In general, the present subject matter generally provides a torque converter with a thrust washer that is insert molded onto a component of the torque converter, such as a stator, a turbine, a one-way clutch, and/or an impeller of torque converter. By insert molding the thrust washer, the torque converter may be less complex, produced with fewer processes, and/or with less parts than known torque converters.

In example embodiments, a method for forming a thrust washer in a torque converter includes positioning a torque converter component insert within a mold and molding a thermoplastic material onto the torque converter component insert within the mold in order to form a thrust washer on the torque converter component insert from the thermoplastic material.

In a first example aspect, the torque converter component insert may include a retention mount that defines an undercut. During the molding of the thermoplastic material onto the torque converter component insert, the thermoplastic material may flow into the undercut. Interference between the retention mount and the thrust washer may mount the thrust washer to the torque converter component insert at the retention mount. The retention mount may define an annular surface at a distal end portion of the retention mount, and the undercut may be defined between the distal end portion of the retention mount and a proximal end portion of the retention mount. The annular surface of the retention mount may be disposed within the thrust washer.

In a second example aspect, the torque converter component insert may be a cast aluminum torque converter component insert.

In a third example aspect, the torque converter component insert may include a stator. The stator may include an annular bearing support, a plurality of stator blades, and a web extending radially between the annular bearing support and the plurality of stator blades. The thrust washer may be positioned at the annular bearing support of the stator.

In a fourth example aspect, the torque converter component insert may include an impeller, a turbine, or a one-way clutch.

In a fifth example aspect, the thrust washer may define an annular bearing surface after forming the thrust washer on the torque converter component insert from the thermoplastic material.

Each of the example aspects recited above may be combined with one or more of the other example aspects recited above in certain embodiments. For instance, all of the five example aspects recited above may be combined with one another in some embodiments. As another example, any combination of two, three, or four of the five example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

In example embodiments, a torque converter includes an impeller, a turbine, a stator, a one-way clutch, and an insert molded thrust washer formed onto a retention mount that is integrally formed on one of the impeller, the turbine, the one-way clutch, and the stator. The retention mount defines an undercut. At least a portion of the insert molded thrust washer is disposed within the undercut. Interference between the retention mount and the insert molded thrust washer mounts the insert molded thrust washer to the retention mount.

In a sixth example aspect, the retention mount may define an annular surface at a distal end portion of the retention mount, and the undercut may be defined between the distal end portion of the retention mount and a proximal end portion of the retention mount. The annular surface of the retention mount may be disposed within the thrust washer.

In a seventh example aspect, the retention mount may be integrally formed on the stator. The stator may be a cast aluminum stator. The stator may include an annular bearing support, a plurality of stator blades, and a web extending radially between the annular bearing support and the plurality of stator blades. The thrust washer may be positioned at the annular bearing support of the stator.

In an eighth example aspect, the retention mount may be integrally formed on one of the impeller, the turbine, and the one-way clutch.

In a nineth example aspect, the thrust washer may be a thermoplastic thrust washer. The thrust washer may define an annular bearing surface.

Each of the example aspects recited above may be combined with one or more of the other example aspects recited above in certain embodiments. For instance, all of the four example aspects recited above, i.e., the sixth through the nineth example aspects, may be combined with one another in some embodiments. As another example, any combination of two or three of the four example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a schematic view of a torque converter according to an example embodiment of the present subject matter.

FIG. 2 is a partial, section view of a stator of the example torque converter of FIG. 1.

FIG. 3 is another partial, section view of the stator of the example torque converter of FIG. 1.

FIG. 4 is a flow chart of a method for forming a thrust washer on a torque converter component according to an example embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

Example embodiments of the present disclosure are directed to a torque converter component, such as a stator or one-way clutch, with an insert molded thrust washer. Utilizing the insert molded thrust washer may advantageously reduce the complexity of an associated torque converter, e.g., by reducing the number of processes and/or components required to provide the thrust bearing, e.g., relative to known torque converters.

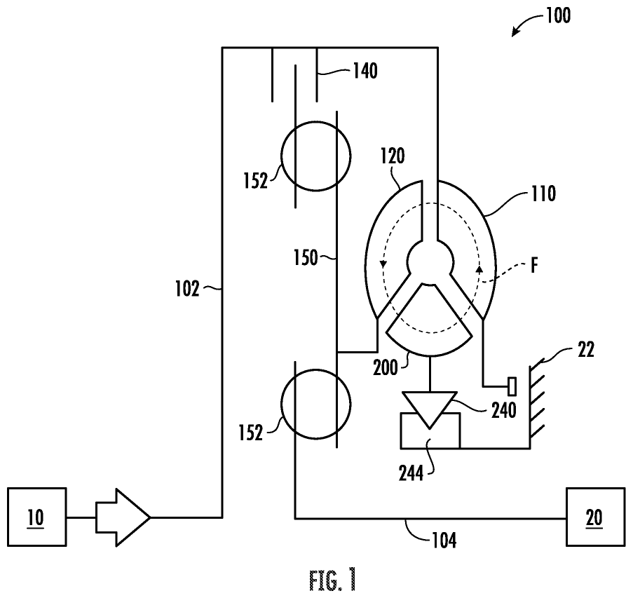

FIG. 1 is a schematic view of a torque converter 100 according to an example embodiment of the present subject matter. Torque converter 100 may be used in a suitable vehicle. For example, torque converter 100 may be installed in a passenger vehicle, such as a car, truck or sport utility vehicle (SUV). As may be seen in FIG. 1, torque converter 100 may be arranged in power flow between an engine 10 and an automatic transmission 20. Thus, torque converter 100 may be configured to transmit torque from engine 10 to automatic transmission 20. In particular, engine 10 may be an internal combustion engine, such as a gasoline or diesel engine, that is coupled to an input 102 of torque converter 100, that may include or correspond to a housing of torque converter 100. It will be understood that the internal combustion engine may be connected to input 102 by a flex plate or similar connection. Torque converter 100 may transmit the rotation of engine 10 to an output 104 of torque converter 100, as discussed in greater detail below.

Torque converter 100 may be used in or with any suitable automatic transmission. For example, automatic transmission 10 may be constructed or arranged in a similar manner to the automatic transmission described in U.S. Pat. No. 8,398,522 to Bauknecht et al., which is hereby incorporated by reference in its entirety for all purposes.

Torque converter 100 includes features for hydraulically coupling input 102 and output 104. For example, torque converter 100 may include a pump or impeller 110 and a turbine 120. Impeller 110 may be rotationally fixed to input 102. Thus, engine 10 may rotate impeller 110 by rotating input 102. Conversely, turbine 120 may be rotationally fixed to output 104. Thus, rotation of turbine 120 may also rotate output 104.

An interior of torque converter 100 may be at least partially filled with a fluid F that is flowable between impeller 110 and turbine 120. In particular, engine 10 may drive rotation of impeller 110 such that impeller 110 urges the fluid F against turbine 120. As the fluid F from impeller 110 impacts turbine 120 within torque converter 100, the fluid F drives rotation of turbine 120. Because turbine 120 is coupled to output 104, output 104 may rotate due to the fluid F from impeller 110 impacting turbine 120.

As may be seen from the above, the fluid F within torque converter 100 may hydraulically couple input 102 and output 104. Such hydraulic coupling may allow power transfer from engine 10 to automatic transmission 20 via torque converter 100 while also allowing relative rotation between impeller 110 and turbine 120 and between input 102 and output 104. Thus, e.g., when an associated vehicle is stopped or operating at low speeds, the fluid F within torque converter 100 may hydraulically couple input 102 and output 104 to provide power transfer from engine 10 to automatic transmission 20 while also allowing relative rotation between input 102 and output 104 to avoid stalling engine 10.

Torque converter 100 may further include a stator 200. Stator 200 may be arranged between turbine 120 and impeller 110. For example, as noted above, the fluid F within torque converter 100 may be driven from impeller 110 against turbine 120 in order to rotate output 104. After impacting turbine 120, the fluid F returns to impeller 110 within torque converter 100. Stator 200 deflects the fluid F returning to impeller 110 from turbine 120. By changing the direction of the fluid F between turbine 120 and impeller 110, stator 200 may increase a torque of turbine 120. As may be seen from the above, the fluid F within torque converter 100 may form a recirculating flow path from impeller 110 to turbine 120, from turbine 120 to stator 200, and from stator 200 back to impeller 110.

Torque converter 100 also includes features for mechanically coupling input 102 and output 104. For example, torque converter 100 may include a lock-up clutch 140. Lock-up clutch 140 is operable to selectively couple input 102 to output 104. When lock-up clutch 140 is open, lock-up clutch 140 may not connect input 102 to output 104 or may only provide negligible torque transfer between input 102 and output 104, e.g., due to fluid sheering between plates of lock-up clutch 140. As may be seen from the above, the fluid F within torque converter 100 may hydraulically couple input 102 and output 104 when lock-up clutch 140 is open. Conversely, lock-up clutch 140 may connect or couple input 102 to output 104 when lock-up clutch 140 is closed. Thus, e.g., input 102 may be directly coupled and/or rotationally fixed to output 104 via lock-up clutch 140 when lock-up clutch 140 is closed.

As may be seen from the above, lock-up clutch 140 may mechanically couple input 102 and output 104 when lock-up clutch 140 is closed, and the hydraulic coupling provided by the fluid F may be bypassed. Such mechanical coupling may allow power transfer from engine 10 to automatic transmission 20 without relative rotation between input 102 and output 104 or with negligible relative rotation between input 102 and output 104, e.g., due to slipping between the plates of lock-up clutch 140. Thus, e.g., when an associated vehicle is operating at high speeds, lock-up clutch 140 may close for mechanical coupling between input 102 and output 104 and to provide more efficient power transfer from engine 10 to automatic transmission 20.

Torque converter 100 may also include a torsion damper 150. Torsion damper 150 is disposed in the, e.g., hydraulic and/or mechanical, power flow between input 102 and output 104. Torsion damper 150 is configured to attenuate rotary oscillations of engine 10 from being transferred into automatic transmission 20 through torque converter 100. Torque converter 100 may include one or more series of coil springs, one or more sets of moving masses, and combinations thereof (indicated generally with 152) that temporarily store energy occurring in rotational irregularities of engine 10 and then guide such energy into automatic transmission 20 with a smoother speed characteristic and/or torque characteristic. As an example, torsion damper 150 may include turbine torsional vibration dampers, two-damper converters, mass pendulums, etc. Thus, torsion damper 150 may assist with attenuating engine rotary oscillations to improve shift quality in automatic transmission 20 and/or improve acoustic properties relative to torque converters without torsion dampers.

Torque converter 100 may further include a freewheel or one-way clutch 240. One-way clutch 240 may be configured to allow stator 200 to rotate in a first rotational direction, e.g., that corresponds to the rotational direction of engine 10 and input 102, and may block rotation of stator 200 in a second, opposite rotational direction. For example, during operation of torque converter 100, a rotation speed of output 104 may increase and approach a rotation speed of input 102. In such conditions, stator 200 may rotate freely in the first rotational direction in the current of the fluid F on one-way clutch 240. Thus, torque converter 100 may act as a “pure” fluid clutch without torque multiplication from stator 200. An inner race 244 of one-way clutch 240 may be fixed to a housing 22, e.g., of automatic transmission 20.

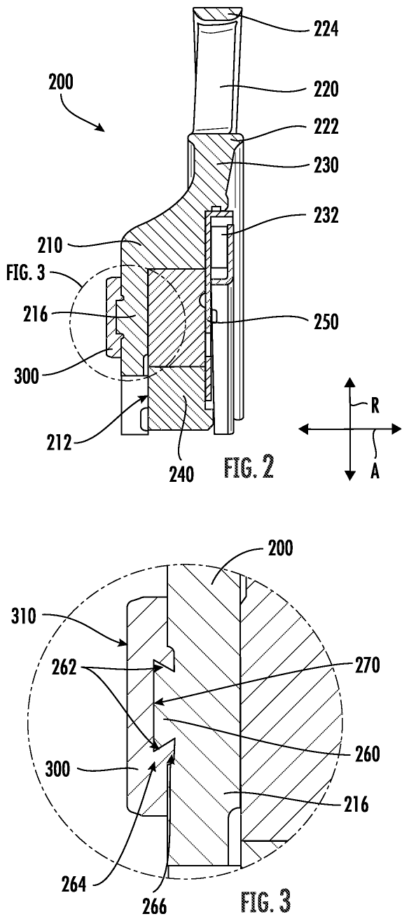

FIG. 2 is a partial, section view of certain components of torque converter 100, including stator 200 and a thrust washer 300. FIG. 3 is another partial, section view of stator 200 and thrust washer 300. As discussed in greater detail below, thrust washer 300 has various benefits over known thrust washers for torque converters. For example, thrust washer 300 may be molded onto a component of torque converter 100. Thus, e.g., thrust washer 300 may advantageously formed on torque converter 100 without breaking thrust washer 300. Stator 200 may define an axial direction A, a radial direction R, and a circumferential direction (not shown), which is perpendicular to the axial direction A and the radial direction R.

As shown in FIG. 2, stator 200 may include an annular bearing support 210. Annular bearing support 210 may support various components of stator 200, including one-way clutch 240. For example, annular bearing support 210 may define a center opening 212. One-way clutch 240 may be disposed at center opening 212 of annular bearing support 210. Annular bearing support 210 may have a generally circular cross-section shape, e.g., in a plane that is perpendicular to the axial direction A.

A bearing cap 250 may be mounted to annular bearing support 210 at center opening 212. Bearing cap 250 may assist with mounting one-way clutch 240 to annular bearing support 210. For example, one-way clutch 240 may be positioned between bearing cap 250 and a flange 216 of annular bearing support 210, e.g., along the axial direction A. Flange 216 may extend inwardly along the radial direction R from annular bearing support 210, and flange 216 may be positioned opposite bearing cap 250 about one-way clutch 240, e.g., along the axial direction A. Various components of one-way clutch 240, e.g., an outer bearing ring, an inner bearing ring, rollers/bearings, etc., may be held between flange 216 and bearing cap 250 on annular bearing support 210.

Stator 200 may also include a plurality of stator blades 220. Stator blades 220 may be shaped to deflect and reorient the fluid F returning to impeller 110 from turbine 120, as noted above. Stator blades 220 may extend along the radial direction R, e.g., from an inner ring support 222 to an outer ring support 224. Stator blades 220 may also be distributed, e.g., uniformly, along the circumferential direction. Stator blades 220 may include no less than ten (10) stator blades, no less than twenty (20) stator blades, no less than thirty (30) stator blades, etc. in various example embodiments.

Stator 200 may further include a web 230. Web 230 may extend, e.g., along the radial direction R, between annular bearing support 210 and stator blades 220. Thus, web 230 may connect or couple annular bearing support 210 and stator blades 220. In particular, web 230 may connect or couple annular bearing support 210 and stator blades 220 such that stator blades 220 are rotationally fixed relative to annular bearing support 210.

As shown in FIGS. 2 and 3, torque converter 100 also includes a thrust washer 300. Thrust washer 300 may be positioned at and/or formed on flange 216 or web 230. Thrust washer 300 may contact and slide against another component of torque converter 100, such as housing 102 of torque converter 100, torsion damper 150, a shaft, a hub, etc. Thus, e.g., force may be transferred between housing 102 of torque converter 100 and stator 200 via the interface formed with thrust washer 300.

Torque converter 100 may also include a thrust bearing 232. Thrust bearing 232 may extend from torque converter 100 (e.g., from bearing cap 250) to another component of torque converter 100, such as housing 102 of torque converter 100 or torsion damper 150. Thus, e.g., axial forces may be transferred between stator 200 and torsion damper 150 via the interface formed with thrust bearing 232. As a specific example, bearing cap 250 may form a first race of thrust bearing 232, a second race may be positioned on another component of torque converter 100, and bearings may roll on the first and second races. Thrust bearing 232 be positioned opposite thrust washer 300 on torque converter 100, e.g., along the axial direction A. Thus, e.g., one-way clutch 240 may be disposed between thrust bearing 232 and thrust washer 300.

Thrust washer 300 may be insert molded onto a component of torque converter 100. For instance, as shown in FIGS. 2 and 3, thrust washer 300 may be insert molded onto stator 200. Thus, thrust washer 300 and forming of thrust washer 300 is described in greater detail below in the context of stator 200. However, it will be understood that thrust washer 300 may be formed in the same or similar manner on other components of torque converter 100, such as impeller 110, turbine 120, and/or one-way clutch 240. As discussed in greater detail below, by insert molding thrust washer 300 on such components, torque converter 100 may be less complex, be produced with fewer processes, and/or be produced with fewer components than known torque converters.

As shown in FIG. 3, thrust bearing 300 may be insert molded on a retention mount 260, such as a projection. Retention mount 260 is positioned on stator 200. For instance, retention mount 260 may be integrally formed on stator 200. Thus, e.g., retention mount 260 may be formed from a single, common material with stator 200. Moreover, retention mount 260 may be formed from a single, common material with annular bearing support 210 (e.g., flange 216) of stator 200 in certain example embodiments. As an example, stator 200 may be cast (e.g., and subsequently machined) to form retention mount 260 on stator 200. Thus, retention mount 260 may be formed from cast metal, e.g., aluminum, with stator 200.

Retention mount 260 may define an undercut 262. For instance, retention mount 260 may extend from a proximal end portion 266 (e.g., at annular bearing support 210, such as flange 216) to a distal end portion 264, e.g., along the axial direction A. Undercut 262 may be defined between distal end portion 264 of retention mount 260 and proximal end portion 266 of retention mount 260. For example, retention mount 260 may be tapered, e.g., such that a cross-section area of retention mount 260 in a plane that is perpendicular to the axial direction A decreases along the axial direction A from distal end portion 264 of retention mount 260 towards proximal end portion 266 of retention mount 260. Undercut 262 may be defined by the decreasing cross-sectional area of retention mount 260, e.g., along the axial direction A. Undercut 262 assists with mounting thrust bearing 300 on retention mount 260. For instance, at least a portion of thrust bearing 300 may be disposed within undercut 262, and interference between retention mount 260 and thrust bearing 300 at undercut 262 may block movement of thrust bearing 300 relative to stator 200, e.g., along the axial direction A. Thus, interference between retention mount 260 and thrust bearing 300 may mount thrust bearing 300 to stator 200.

Retention mount 260 may define an annular surface 270 at distal end portion 264 of retention mount 260. Undercut 262 may be defined on both sides of annular surface 270, e.g., along the radial direction R, in certain example embodiments. Annular surface 270 of retention mount 260 may be disposed within thrust bearing 300 in certain example embodiments. Moreover, annular surface 270 of retention mount 260 may be oriented, e.g., about, parallel to a bearing surface 310 of thrust bearing 300 that engages or slides on another component of torque converter 100. Annular surface 270 may include additional features to assist with mounting thrust bearing 300 to stator 200. For example, grooves, knurls, projections, etc. may be formed on annular surface 270 or other portions of stator 200 to engage thrust bearing 300 and hereby assist with mounting thrust bearing 300 to stator 200. Bearing surface 310 may be annular in certain example embodiments. Bearing surface 310 may also include channels (not shown) that extend along the radial direction R across bearing surface 310, e.g., to allow cooling fluid to flow between thrust bearing 300 and another component of torque converter 100.

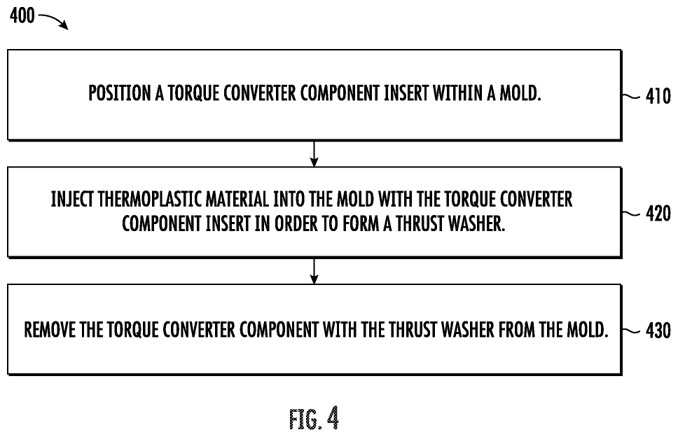

Referring now to FIG. 4, a flow diagram of a method 300 for forming a thrust washer on a torque converter component is illustrated. Method 300 will generally be described with reference to stator 200 and thrust washer 300 and FIGS. 2 and 3. However, it will be understood that method 300 may be used to form a thrust washer on any suitable torque converter component in alternative example embodiments. In addition, although FIG. 4 depict steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

At 410, method 400 includes positioning a torque converter component insert within a mold. The torque converter component insert is cast, machined, or otherwise formed prior to inserting the torque converter component insert into the mold at 410. For instance, stator 200 may be positioned within the mold, e.g., after casting stator 200 from aluminum. In alternative example embodiments, impeller 110, turbine 120, or one-way clutch 240 may be disposed within the mold at 410. The mold 410 may be sized for receipt of the torque converter component insert with a void corresponding to the shape of thrust washer 300.

At 420, method 400 includes injecting thermoplastic material into the mold with the torque converter component insert. Thus, the thermoplastic material may be injected into the mold with torque converter component insert in order to fill a void within the mold with the thermoplastic material and thereby form the thrust bearing on the torque converter component insert. For instance, the thermoplastic material may be molded onto stator 200 within the mold in order to form thrust washer 300 on stator 200 from the thermoplastic material. In particular, the thermoplastic material may be injected into the mold such that at least a portion of the thermoplastic material flows into undercut 262. After the thermoplastic material sets within the mold, interference between retention mount 260 and thrust washer 300 secures and mounts thrust washer 300 to the torque converter component insert (e.g., stator 200) at retention mount 260. Thus, thrust bearing 300 may be quickly and securely formed on stator 200 via an insert molding process.

At 430, method 400 includes removing the torque converter component from the mold with a thrust washer formed from the thermoplastic material thereon. For instance, stator 200 may be removed from the mold at 430 with thrust washer 300 formed on stator 200 from the thermoplastic material.

Utilizing method 400, a thrust washer may be formed on a torque converter component with fewer processes and/or with less parts than known torque converters.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.
10 Engine
20 Automatic transmission
22 Housing
100 Torque converter
102 Input
104 Output
110 Impeller
120 Turbine
140 Lock-up clutch
150 Torsion damper
152 Dampers
200 Stator
210 Annular bearing support
212 Center opening
216 Flange
220 Stator blades
222 Inner support ring
224 Outer support ring
230 Web
232 Thrust bearing
240 One-way clutch
244 Inner race
250 Bearing cap
260 Retention mount
262 Undercut
264 Distal end portion
266 Proximal end portion
300 Thrust washer
310 Bearing surface
F Fluid
A Axial direction
R Radial direction

What is claimed is:

1. A method for forming a thrust washer in a torque converter, comprising:
positioning a torque converter component insert within a mold; and
molding a thermoplastic material onto the torque converter component insert within the mold in order to form a thrust washer on the torque converter component insert from the thermoplastic material.

2. The method of claim 1, wherein:
the torque converter component insert comprises a retention mount that defines an undercut;
during the molding of the thermoplastic material onto the torque converter component insert, the thermoplastic material flows into the undercut; and
interference between the retention mount and the thrust washer mounts the thrust washer to the torque converter component insert at the retention mount.

3. The method of claim 2, wherein the retention mount defines an annular surface at a distal end portion of the retention mount, and the undercut is defined between the distal end portion of the retention mount and a proximal end portion of the retention mount.

4. The method of claim 3, wherein the annular surface of the retention mount is disposed within the thrust washer.

5. The method of claim 1, wherein the torque converter component insert is a cast aluminum torque converter component insert.

6. The method of claim 1, wherein the torque converter component insert comprises a stator.

7. The method of claim 6, wherein the stator comprises:
an annular bearing support;
a plurality of stator blades; and
a web extending radially between the annular bearing support and the plurality of stator blades.

8. The method of claim 7, wherein the thrust washer is positioned at the annular bearing support of the stator.

9. The method of claim 1, wherein the torque converter component insert comprises an impeller, a turbine, or a one-way clutch.

10. The method of claim 1, wherein the thrust washer defines an annular bearing surface after forming the thrust washer on the torque converter component insert from the thermoplastic material.

11. A torque converter, comprising:
an impeller;
a turbine;
a stator;
a one-way clutch; and
an insert molded thrust washer formed onto a retention mount that is integrally formed on one of the impeller, the turbine, the one-way clutch, and the stator,
wherein the retention mount defines an undercut, at least a portion of the insert molded thrust washer is disposed within the undercut, and interference between the retention mount and the insert molded thrust washer mounts the insert molded thrust washer to the retention mount.

12. The torque converter of claim 11, wherein the retention mount defines an annular surface at a distal end portion of the retention mount, and the undercut is defined between the distal end portion of the retention mount and a proximal end portion of the retention mount.

13. The torque converter of claim 12, wherein the annular surface of the retention mount is disposed within the thrust washer.

14. The torque converter of claim 11, wherein the retention mount is integrally formed on the stator.

15. The torque converter of claim 14, wherein the stator is a cast aluminum stator.

16. The torque converter of claim 15, wherein the stator comprises:
an annular bearing support;
a plurality of stator blades; and
a web extending radially between the annular bearing support and the plurality of stator blades.

17. The torque converter of claim 16, wherein the thrust washer is positioned at the annular bearing support of the stator.

18. The torque converter of claim 11, wherein the retention mount is integrally formed on one of the impeller, the turbine, or the one-way clutch.

19. The torque converter of claim 11, wherein the thrust washer is a thermoplastic thrust washer.

20. The torque converter of claim 19, wherein the thrust washer defines an annular bearing surface.
